(19) United States
(12) Patent Application Publication
(10) Pub. No.: US 2009/0185851 A1
(43) Pub. Date: Jul. 23, 2009

(54) Interior Vehicle Windshield Window Cleaning Kit

(76) Inventors: Cordellia Mapalo, Woodland, CA (US); Don Carothers, Woodland, CA (US)

Correspondence Address: Cordellia Mapalo, 232 Weber Street, Woodland, CA, 95695, US

(21) Appl. No.: 12/017,209

(22) Filed: Jan. 21, 2008

(51) Int. Cl. A47L 1/08; B65D 69/00; A47L 1/06; B60S 1/04; B60S 1/02; B60S 1/50; B60S 3/00; B60S 1/56; B43M 11/06

(52) U.S. Cl. 401/263; 15/121; 206/229

(57) ABSTRACT

A complete portable lightweight interior vehicle windshield/window cleaning kit that sits on the dash-board on any vehicle for use at anytime. This windshield/window cleaning kit cleans the interior windshield/windows on the vehicle. This interior vehicle windshield/window cleaning kit is housed within the body of different shapes, colors and sized animal creations. The synthetic filled animal creations will be different from all others, by having workable cleaning tools housed within its torso. Encased within the torso will be a squeegee, spray bottle for cleaning solution and a towel to wipe off excess fluid from the windshield/windows. This complete interior vehicle windshield/windows cleaning kit will be an improvement over other auto glass windshield cleaning devices, as this interior vehicle windshield/window cleaning kit will be accessible at all times to the driver by being of a size that it can be stored on the dashboard, on the console or in glove compartment.

### FIELD OF INVENTION

The present invention relates to the field of interior vehicle windshield/window cleaning kits in general, and particular to a portable, light weight, conveniently located, readily accessible interior vehicle windshield/window cleaning kit for the interior surface of vehicle windows.

This interior vehicle windshield/window cleaning kit lays on the dash board, center console, the window side pocket or glove compartment of a vehicle and is readily available to the driver or passenger of the vehicle for the purpose of cleaning the interior of the vehicle windshield/windows.

This interior vehicle windshield/window cleaning kit is in itself a complete interior windshield/window cleaning kit, which includes cleaning solution, a squeegee to remove liquids and a towel to absorb any excess fluids left on the interior of the windshield from fog, rain, condensation or good old fashion dirt and grim.

### BACKGROUND OF INVENTION

Self contained window/windshield cleaning or washing devices are known and are described in U.S. Patent Number 2003229962 (DeHart) and U.S. Patent Number 20030037390 (Leblanc).

These present inventions relate to washing/cleaning tools combined to make cleaning kits and more particularly to portable, self contained units. These inventions claim to have workable tools capable of affording the operator the use of a cleaning fluid, a sponge, a squeegee, a handle of sufficient length, a scraper and/or a brush. Most of these inventions provide compressible container of a novel type that effectively serve as the handle for the cleaning tools mounting thereon.

While these devices fulfill their particular objective, the above patents do not disclose a new portable, self contained, convenient, lightweight combination of windshield/window cleaning tools. These inventions all encompass elongated shafts with head portion, elongated resiliently flexible squeegee blades, elongated compressible sponge members, elongated handles for use by the operator and a resiliently compressible scrubbing pad. These devices are not stored within reach of the operator of the vehicle without leaving the operation station. These devices are not lightweight with easy move ability to the operator of the vehicle.

In this respect, the interior vehicle windshield/window cleaning kit according to the present invention is substantially different from the conventional concepts and designs of any prior art, and in so doing provides a new art apparatus developed to clean the interior windshield/window of a automobile or any vehicle and adds in the particular, compacted, complete, convenient locations and easy accessibility to the operator of the vehicle without the operator leaving the operational station of the vehicle. This kit was invented to be stored on the dash-board, console, side window pocket or glove compartment of the automobile or vehicle. There are no limits on the move ability of this interior windshield/window cleaning kit due it small compact design. The receptacle or housing unit of my present invention is made of fabric and plastic, and will not rust or scratch the interior surface of the vehicle windshield/windows. The receptacle or housing unit of this new interior vehicle windshield/window cleaning kit being made in the shape of all animals known to mankind will be a stunning addition to the interior of the vehicle.

### SUMMARY OF THE INVENTION

It is the intention of this invention to provide an interior vehicle windshield/window cleaning kit with self contained tools which will improve the convenience and easy access to a cleaning device which will clean the interior of a windshield or windows. It is the intention of this invention to provide easy access and easy storability of this interior vehicle windshield/window cleaning kit within the reach of the operator of the vehicle. This invention is designed to sit on the dash-board, console, in the window side pocket or the glove compartment of a vehicle.

This invention is a three component interior vehicle windshield/window cleaning kit that includes a spray bottle for spraying window cleaner on the interior windshield or windows of the vehicle, a soft rubber cleaning blade for swiping the windshield or windows of the vehicle to remove the window cleaner, grim or dirt and an absorbent towel to wipe off any access cleaning fluid left on the interior of a windshield or windows of the vehicle.

This interior vehicle windshield/window cleaning kit invention according to the present inventions is substantially different from the conventional concepts and designs of any prior art. This invention provides a new use for a spray bottle, a squeegee and a towel which is all combined into a new art apparatus and housed in a receptacle or housing unit in the shapes of animals known to mankind. This invention was developed to clean the interior windshield/windows of a vehicle and adds in particular a convenient location and easy access to the interior windshield/window cleaning kit to the vehicle operator or any passenger in the vehicle. This invention made of a fabric or plastic, in the shapes of animals known to mankind is stored on the dash-board, console, side window pocket or glove compartment of the automobile or vehicle.

### BRIEF DESCRIPTION OF THE DRAWINGS

An embodiment of the present invention will now be disclosed, by way of, illustrations in reference to the following drawings in which:

FIG. 1 is a perspective view of an embodiment of the interior vehicle window/windshield cleaning kit from the side according to the present invention when in use.

FIG. 2 is a perspective view of an embodiment of the interior vehicle window/windshield cleaning kit from the underside according to the present invention when in use.

FIG. 3 is an exploded perspective view of an embodiment of an interior vehicle window/windshield cleaning kit according to the present invention assembled when in use.

FIG. 4 is an exploded perspective view of an embodiment of the towel tube receptacle at the rear of the interior vehicle window/windshield cleaning kit with the towel inserted to show how it will attach to the rear of the towel tube receptacle of the invention.

FIG. 5 is an exploded perspective view of an embodiment of the receptacle or housing unit of the interior vehicle window/windshield cleaning kit without the cleaning tools attached to the invention.

FIG. 6 is a perspective view of an embodiment of the receptacle or housing unit of the interior vehicle window/windshield cleaning kit with the head portion, eyes, nose, mouth, and ears attached to the receptacle or housing unit of the invention without the cleaning tools attached. The embodiment shows the head portion filled with the synthetic filler which will form one of the many shapes of the invention.

FIG. 7 is a perspective view of an embodiment of the receptacle or housing unit of the interior vehicle window/windshield cleaning kit with the receptacle or housing unit assembled showing the openings for the spray bottle, squeegee and the towel tube receptacle. FIG. 7 is additionally displaying an exploded embodiment of the base and squeegee which will be inserted into the middle opening in the embodiment of the receptacle or housing unit. The base, which can be made of plastic, styrofoam, wood or a resilient material, and a squeegee, strip made of resilient material, will be assembled together with glue, stitched or made as a whole piece of elongated resilient material that will be placed into the invention.

FIG. 8 is a view similar to FIG. 7, presenting an embodiment of the interior vehicle window/windshield cleaning kit with the receptacle or housing unit assembled displaying the squeegee inserted into the housing unit and attached with glue or stitching closing the underside middle opening of the embodiment. FIG. 8 is additionally displaying the opening for the spray bottle and towel tube receptacle and shows the synthetic filler forming the shape of the receptacle or housing unit of the invention.

FIG. 9 is a view similar to FIG. 8, presenting the embodiment of the interior vehicle window/windshield cleaning kit with the receptacle or housing unit assembled showing the opening for the spray bottle, towel tube receptacle and displaying the squeegee inserted into the embodiment. An exploded drawing of the towel tube receptacle is inserted into the drawing next to the opening in the receptacle or housing unit in which the towel tube receptacle will be placed into the invention.

FIG. 10 is a view similar to FIG. 9, presenting the embodiment of the interior vehicle window/windshield cleaning kit with the receptacle or housing unit assembled displaying the towel tube receptacle inserted into the housing unit attached with glue or stitching closing the rear of the embodiment. An exploded view of the towel showing the plastic or metal ring assembly is displayed next to the towel tube receptacle. FIG. 10 is additionally displaying the opening for the spray bottle and the squeegee and showing the synthetic filler shaping the receptacle or housing unit into one of the many shapes and sizes of the invention.

FIG. 11 is an exploded perspective of an embodiment of the spray bottle device shown in FIG. 3 which will be inserted into the front/top area of the receptacle or housing unit of the interior window/windshield cleaning kit.

FIG. 12 is a view similar to FIG. 10, presenting the embodiment of the interior vehicle window/windshield cleaning kit with the receptacle or housing unit assembled displaying the spray bottle inserted into the housing unit attached with glue or stitching closing the front/top area in the embodiment. An exploded view of a piece of fabric to cover cap/nozzle of the spray bottle attached by glue or stitching under head portion to cover cap/nozzle if needed for that particular receptacle or housing unit shape. FIG. 12 is additionally displaying the opening for the spray bottle and presenting the towel tube attached to the invention.

FIG. 13 is a view similar to FIG. 3, is an exploded perspective view of the underside embodiment of an interior vehicle window/windshield cleaning kit according to the present invention when in use. This embodiment presents all the attached tools of the invention.

FIG. 14 is a view similar to FIG. 2, presenting a frontal perspective embodiment of the interior vehicle window/windshield cleaning kit according to the present invention with a different receptacle or housing unit displaying spray bottle, squeegee, towel tube receptacle and towel attached. The perspective of the embodiment shows the synthetic filler processed into the receptacle or housing unit to ensure the recognition of one of the many shapes of the invention.

FIG. 15 is a view similar to FIG. 2, presenting an embodiment of the interior vehicle window/windshield cleaning kit according to the present invention with a different shaped receptacle or housing unit displaying spray bottle, squeegee, towel tube receptacle and towel attached. The perspective of the embodiment shows the synthetic filler processed into the receptacle or housing unit to ensure the recognition of one of the many shapes of the invention.

FIG. 16 is perspective view of a modification to the spray bottle, towel tube receptacle, base of the squeegee and squeegee embodiment. This embodiment shows the new one piece combination cleaning kit that would be inserted into the housing unit or receptacle of the embodiment.

FIG. 17 is a view similar to FIGS. 1 and 2, presenting an embodiment of the interior vehicle window/windshield cleaning kit according to the present invention with a different receptacle or housing unit. This embodiment also contains a modified one piece cleaning unit that combined the spray bottle, squeegee, and towel tube receptacle. FIG. 17 is showing the combined one piece cleaning unit with the towel inserted. The perspective of the embodiment shows the synthetic filler processed into the receptacle or housing unit to ensure the recognition of one of the many shapes of the animal representing the receptacle or housing unit.

FIG. 18 is a view similar to FIG. 17, presenting the embodiment of the interior vehicle window/windshield cleaning kit according to the present invention with a different receptacle or housing unit. This embodiment also contains a modified one piece cleaning unit that combined the spray bottle, squeegee, and towel tube receptacle. FIG. 17 is showing the combined one piece cleaning unit with the towel. The perspective of the embodiment shows the synthetic filler processed into the receptacle or housing unit to ensure the recognition of one of the many shapes of the animal representing the receptacle or housing unit.

### DETAILED DESCRIPTION OF PREFERRED EMBODIMENTS OF THE INVENTION

With reference to the drawings in general, the drawings illustrate an interior vehicle windshield/window cleaning kit and more precisely a portable, lightweight, self-contained, easy accessible receptacle or housing unit primarily adapted for the cleaning of the interior windshield/windows of a vehicle. These drawings will describe the current embodiment, it will be understood that I do not intend to limit the cleaning kit to these embodiments. This embodiment will come in various shapes, sizes, fabric, and colors of all animals known to the human civilization. I will cover and describe differences, alternatives and modifications as may be included within the spirit and scope of these embodiments.

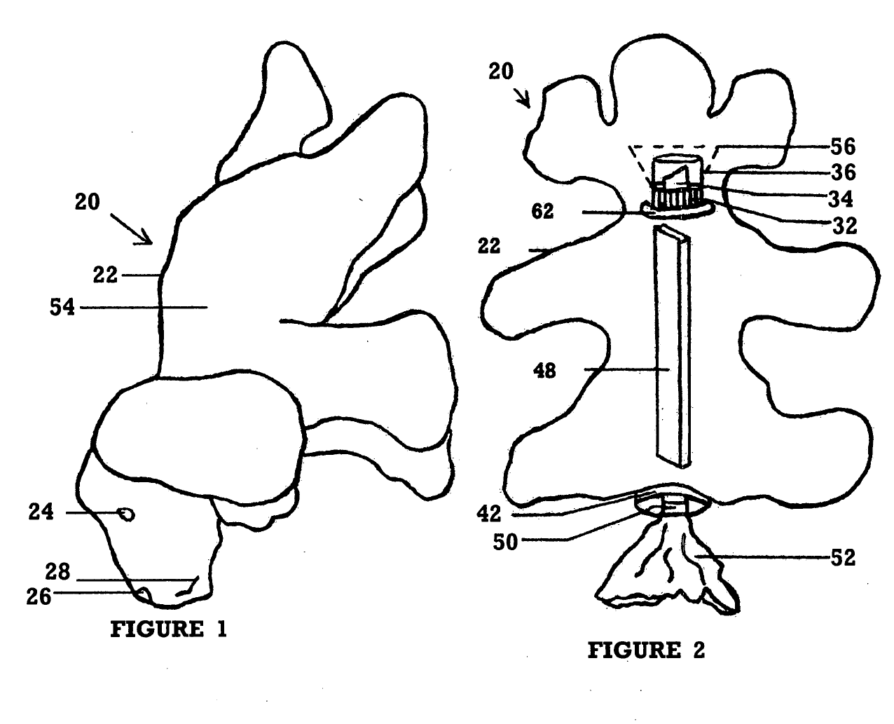

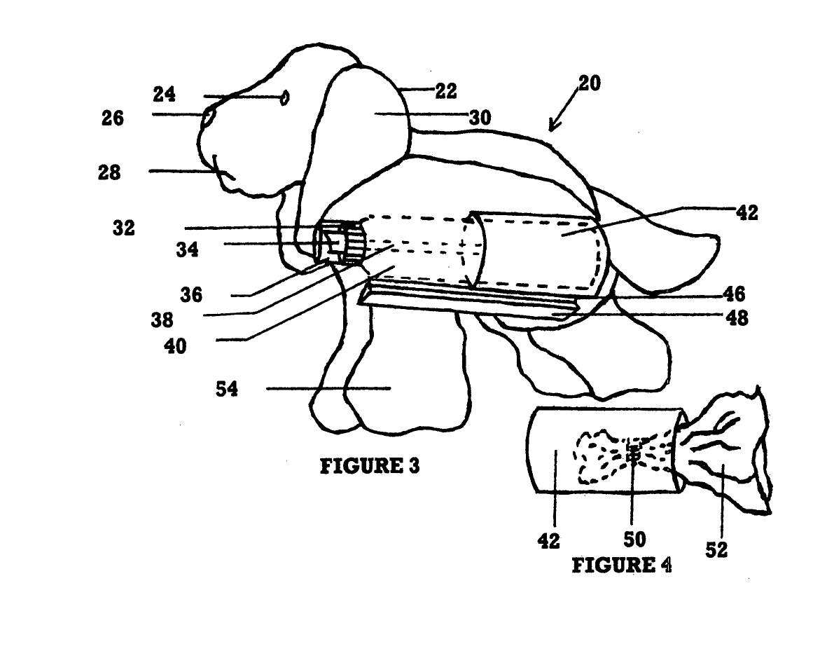

FIGS. 1-3, are illustration of a perspective view of the side, the underside and an exploded underside of the embodiment of the presented interior vehicle windshield/window cleaning kit. The embodiments of the basic receptacle or housing unit 22 can be made of various fabrics, including cottons, wools, etc or even plastic. This embodiment will consist of many different shapes of animals in any size or color. The embodiment of the body of the receptacle or housing 22 units is made to conceal a spray bottle 40, a squeegee 48, a base 46 or a combined squeegee/base 46, 48 and a towel tube receptacle 42. The head portion 60 of the receptacle or housing unit 22 of the embodiment will be used for concealing the cap 36 of the spray bottle 40 and the pump nozzle 34 of the spray bottle 40. The head portion 60 of the receptacle or housing unit 22 will also contain the eyes 24, the nose 24, the mouth 28, and the ears 30 of the animal being represented by the receptacle or housing unit 22. If needed, a cover or flap 56 will be attached under the head portion 60 on certain shapes of the receptacle or housing unit 22 to conceal the cap 36 of the spray bottle 40 and pump nozzle 34 of the spray bottle 40. The front/top opening 62 of the receptacle or housing unit 22 will be used for concealing the neck 32 of the spray bottle 40, tube 38 within the spray bottle 40, and the base of the spray bottle 40. The middle opening 68 of the receptacle or housing unit 22 will be used to conceal the base 46 or handgrip of the squeegee 48 and elongated flexible squeegee 48 blades or a unit combination of both base and squeegee 46, 48. The bottom/rear opening 66 of the receptacle or housing unit 22 will be used for concealing the towel tube receptacle 42 which is presented in this embodiment as a generally cylindrical outer configuration. Synthetic filler 54 will be added to bring out the shape and character of each animal being represented by the receptacle or housing unit 22.

FIG. 4 illustrates the embodiment of the absorbent towel 52 with a plastic or metal ring assembly 50 allowing easy insertion into the towel tube receptacle 42.

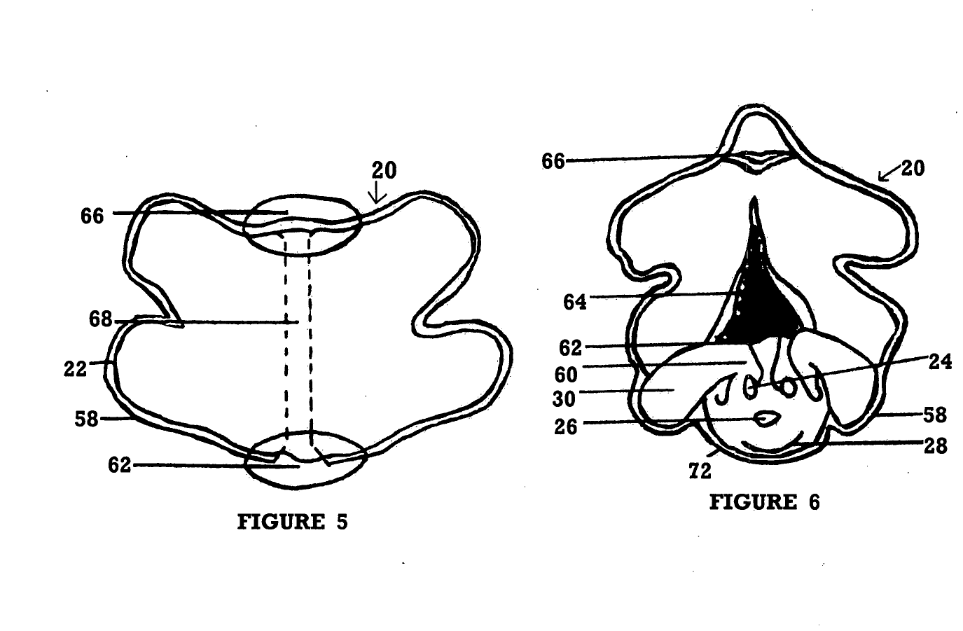

FIG. 5 illustrates a perspective view of the receptacle or housing unit 22 of the embodiment. The embodiment shows the stitching 58 of the two panels 72 of fabric or plastic cut into the animal being represented by the receptacle or housing unit 22. The two panels 72 are stitched 58 or glue together forming the front/top opening 62, middle opening 68 and bottom/rear opening 66 of the receptacle or housing unit 22 of the embodiment. The front/top opening 62 will be for attaching the head portion 60 of the embodiment to the receptacle or housing unit 22. The front/top opening 62 will contain the spray bottle 40, the middle opening 68 will contain the base 46 and squeegee 48 and the bottom/rear opening 66 will contain the towel tube receptacle 42. This receptacle or housing unit 22 can range in size from approximately 4-18 inches in length, 4-8 inches is width and 4-8 inches in depth. This receptacle or housing unit 22 can be made out of any fabric including but not limited to wool, cotton, satin, etc or plastic. The receptacle or housing unit 22 of this embodiment can be on any color or animal shape known to human civilization.

FIG. 6 illustrates the perspective view of the receptacle or housing unit 22 of the embodiment with the head portion 60 assembled. The head portion 60 is generally circular in configuration; however, to ensure the representation of the animal being represented in the receptacle or housing unit 22, the head portion 60 may take on different shapes or sizes. The head portion 60 will consist of panel's 72 of fabric or plastic shaped into the face of the animal being represented by the receptacle or housing unit 22. The panels 72 are stitched 58 or glue together forming the head portion 60 of the embodiment. The head portion 60 of the receptacle or housing unit 22 will contain eyes 24, nose 26, mouth 28, and ears 30. The length of head portion 60 should be no more than ¼-½ of the receptacle or housing unit 22 representing the shape of the animal. The head portion 60 of the embodiment should be large enough to permit the nozzle 34 of the spray bottle 40 to adequately spray the liquid contained in the spray bottle 40 onto the windshield/window of the vehicle in a single pumping action. When the head portion 60 is properly attached to the receptacle or housing unit 22, a front/top opening 62 will be formed. FIG. 6 illustrates the interior fabric 64 of the receptacle or housing unit 22 before reversed. FIG. 6 illustrates the receptacle or housing unit 22 and head portion 60 that will be supplied with synthetic filler 54 to bring out the shape of the animal represented by the embodiment.

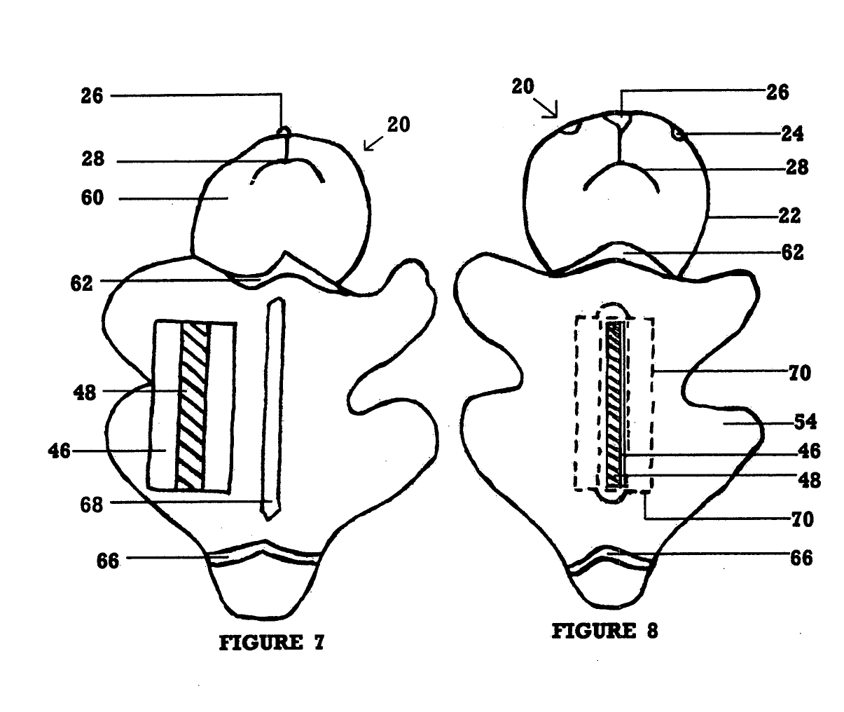

FIG. 7 illustrates a perspective view of the receptacle or housing unit 22 of this embodiment. The head portion 60 and receptacle or housing unit 22 has been reversed to show the outer side of the receptacle or housing unit 22 with the front/top opening 62, the middle opening 68 and bottom/rear opening 66. FIG. 7 illustrates the placement of the mouth 28 and the nose 24. FIG. 7 presents a view of the base 46 and squeegee 48 which will be inserted into the middle opening 68 of the receptacle or housing unit 22. The base 46 of the squeegee 48 has a generally square or rectangle shape no longer than the length of the middle opening 68 of the receptacle or housing unit 22 of the embodiment. The base 46 of the squeegee 48 should be no wider than half the size of the receptacle or housing unit 22 of the embodiment. The base 46 should have an approximate depth of ½ to ¾ inches and sit directly under the fabric in the middle opening 68 of the receptacle or housing unit 22 of the embodiment. The squeegee 48 made of a silicone or similar material blade is then attached to the base 46 with glue or made as a whole base/squeegee 46, 48 combinations. The resiliently flexible squeegee 48 blade is designed for sweeping across the windshield/window to remove the excess water from the windshield/window. FIG. 7 indicates the approximate placement of synthetic filler 54 placed into the embodiment.

FIG. 8 illustrates a perspective view an embodiment similar to FIG. 7 displaying the base/squeegee 46, 48 inserted into the receptacle or housing unit 22 of the embodiment. This base/squeegee 46, 48 will have a generally square or rectangle design for grasping with the hand of the user. In the displayed embodiment, the gripping portion of the base 46 has a generally rectangle configuration and generally has a length greater than the width. The base 46 of the base/squeegee 46, 48 can be approximately 4-8 inches in length and 1-2 inches width. This base 46 can be constructed of rubber, metal, wood, Styrofoam or plastic. Another option of this design is to combine the base/squeegee 46, 48 into a whole piece without having to glue or stitch the base/squeegee 46, 48 together. This combination base/squeegee 46, 48 can be constructed of rubber or a resilient material or any other material known to one skilled in the art of manufacturing squeegees. It is hereby referenced that the squeegee 48 and base 46 can be bonded as one or configured as combined base and blade made out of the reference material above. This base/squeegee 46, 48 designs serves as a handle for manipulating the squeegee 48 while the relatively flexible resilient blade will economically provide for the removal of the excess cleaning solution from the window/windshield. FIG. 8 illustrates the approximate placement of eyes 24, nose 24 and mouth 28 of the embodiment.

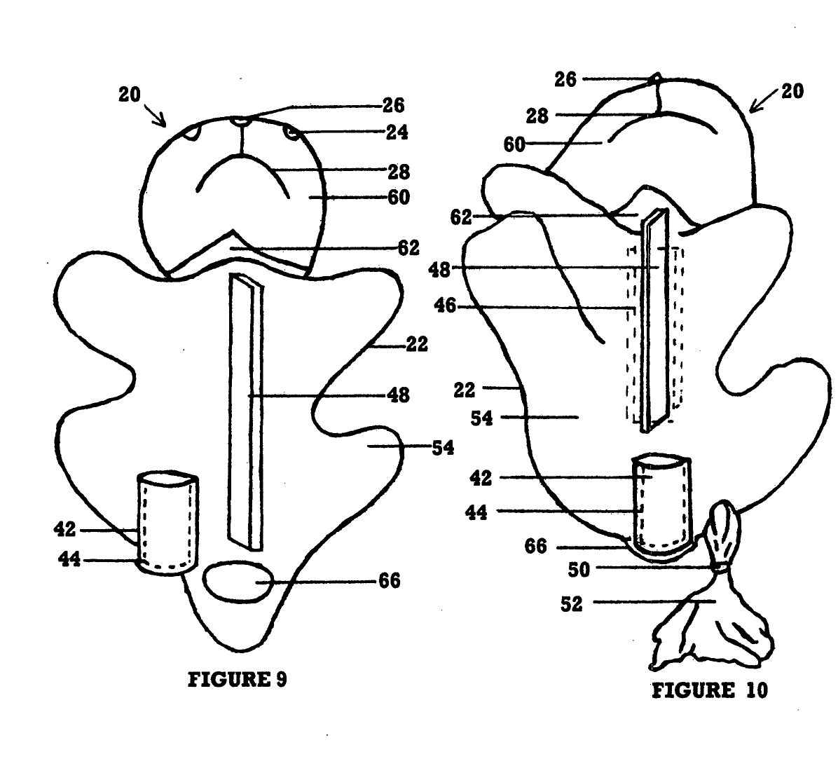

FIG. 9 illustrates a perspective view an embodiment similar to FIG. 8. FIG. 9 is displaying the bottom/rear opening 66 of the receptacle or housing unit 22 of the embodiment. An inserted embodiment of the towel tube receptacle is displayed next to the bottom/rear opening 66 of the receptacle or housing unit 22. This bottom/rear opening 66 will be used for concealing the towel tube receptacle 42 which has a generally cylindrical outer configuration and the stitching 44 or glue area. The towel tube receptacle 42 can be constructed out of plastic, PVC or metal. The towel tube receptacle 42 should be no longer than one-fourth-one half the size of the receptacle or the housing 22 and no wider than the bottom/rear opening 62 of the receptacle unit of the embodiment. FIG. 9 also show the placement of the front/top opening 62 of the receptacle or housing unit, the head portion 60, the mouth 28, the nose 24 and the eyes 24 of the embodiment.

FIG. 10 illustrates perspective view an embodiment similar to FIG. 8. FIG. 10 is displaying the towel tube receptacle 42 and the stitching 44 or glue area on the towel tube receptacle placed into the bottom/rear opening 66 within the receptacle or housing unit 22. Synthetic filler 54 is placed into the rear of the receptacle or housing unit 22 of the embodiment to form the shape of the animal represented. The towel tube receptacle 42 is then secured with stitching 44 or glue to the bottom/rear opening 66 of the receptacle or housing unit 22 using glue or stitching. FIG. 10 shows an illustration of the absorbent towel 52 with a plastic or metal ring assembly 50 to allow easy attachment to the towel tube receptacle 42. FIG. 10 is also illustrating the placement of the base 46 of the squeegee, the squeegee 48, and front/top opening 62 of the receptacle or housing unit, the head portion 60 of the receptacle, the mouth 28 and the nose 24 of the embodiment.

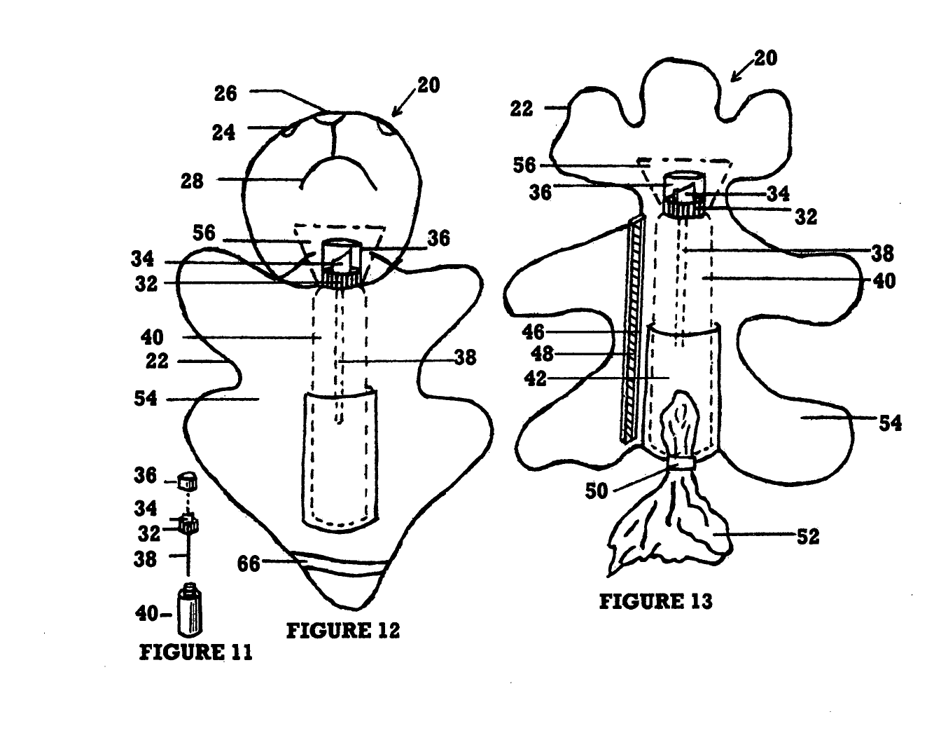

FIG. 11 illustrates a perspective of an embodiment of the spray bottle. This view of spray bottle includes the cap 36, the pump nozzle 34, the neck 36, and the tube 38 within the spray bottle and the base of spray bottle 40. These spray bottles can range in sizes, shapes or colors and be manufactured of any material known to one skilled in the art of spray bottle manufacturing.

FIG. 12 illustrates a perspective of the embodiment of the insertion of the spray bottle 40 being inserted into the front/top opening 62 of the receptacle or housing unit 22 of the embodiment for the purpose of holding a window cleaning liquid to spray the window during the cleaning operation. The spray bottle 40 is equipped with a removable cap 36, when this cap 36 is completely closed it ensures no leakage of the cleaning liquid into the head portion 60 of the receptacle or housing unit 22, a pump nozzle 34 for dispensing the liquid, a neck 32 with threads to attach to the base of the spray bottle 40 and a tube 38 which extends to the bottom of the base of spray bottle 40 when in position. The tube 38 collects liquid from the base of the spray bottle 40; the pump nozzle 34 is compressed and draws liquids up and out the pump nozzle of the spray bottle 40 onto the windshield/window on the vehicle. FIG. 12 displays an embodiment of the cover or flap 56 to hide the nozzle/cap 34,36 of the spray bottle 40 in certain shapes or sizes, this cover or flap 56 will be attached to the front/top opening 62 of the animal being represented by receptacle or housing unit 22 of the embodiment. FIG. 12 also illustrates the nose 24, eyes 24, mouth 28 and the synthetic filler 54 which are part of the embodiment.

FIG. 13 illustrates an exploded embodiment of the embodiment showing all the internal parts exposed. The cover or flap 56 (if needed) is attached to the head portion 60 of the receptacle or housing unit 22 to hide the cap 36 and pump nozzle 34 of the spray bottle 40. The neck 32, tube 38, and base of spray bottle 40 are shown inserted into the front/top opening 62 of the receptacle or housing unit 22. The base 46 and squeegee 48 are shown inserted into the middle opening 68 of the receptacle or housing unit. The base 46 of the squeegee serves as a handle for manipulating the squeegee 48 while the relatively flexible resilient blade will economically provide for the removal of the excess cleaning solution from the window/windshield. The towel tube receptacle 42 is shown inserted into the bottom/rear opening 66 of the receptacle or housing unit 22. The absorbent towel 52 and the plastic or metal ring assembly 50 are shown inserted into the towel tube receptacle 42 in the receptacle or housing unit 22. The towel 52 is designed for absorbing the excess fluid sprayed on the window/windshield of the vehicle. The towel 52 has two exterior faces and a width/length of various sizes, shapes, colors and fabrics depending of the shape or design of the receptacle or housing unit 22. The towel 52 has a plastic or metal ring assembly 50 to allow easy insertion into the towel tube receptacle 42 of the embodiment. FIG. 13 illustrates parts of the receptacle or housing unit 22 that will be supplied with synthetic filler 54 to bring out the shape and character of each animal represented by the embodiment.

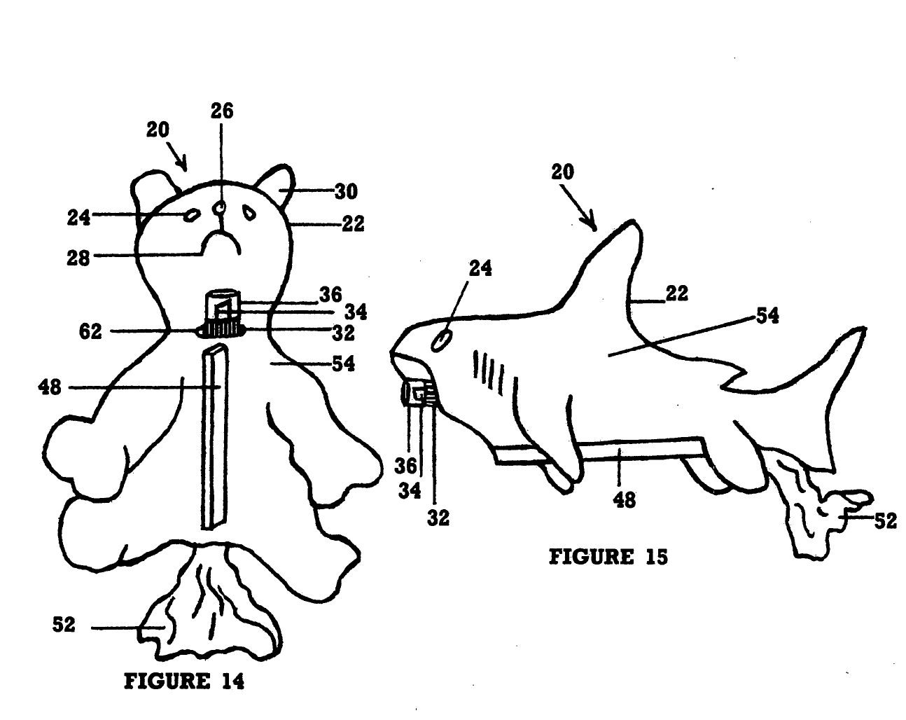

FIGS. 14-15 illustrates additional perspective views of the embodiments in different shaped receptacles or housing units 22 and display the placement of the embodiment parts and tools in those shapes presented. FIGS. 14-15 displays the placement of the eyes 24, nose 24, mouth 28, ears 30 and neck 32 of the spray bottle, pump nozzle 34 of the spray bottle, cap 36 of the spray bottle, tube 38 of spray bottle and the base of spray bottle 40. The front/top opening 62 of the receptacle or housing unit, squeegee 48, ring assembly 52, towel 50, and synthetic filler 54 within the head portion 60 and the receptacle or housing unit 22 of the embodiment.

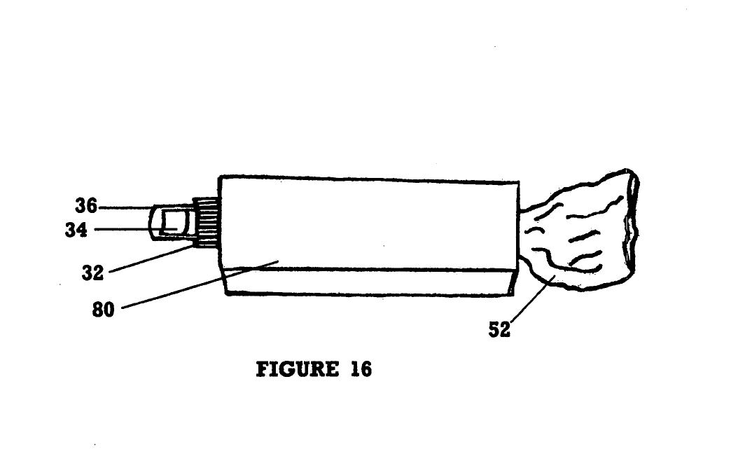

FIG. 16 illustrates a perspective view of a modification to the spray bottle, towel tube receptacle, base and squeegee embodiment in FIGS. 1-15. This modified embodiment would combine a cap 36, pump nozzle 34, neck 36, and base of a spray bottle, a towel tube receptacle, the base of the squeegee and the squeegee into a one piece combination cleaning unit 80. This one piece combination cleaning unit 80 would be manufactured by one skilled in the art of manufacturing plastic or rubber parts. This one piece cleaning unit 80 embodiment would be inserted into the receptacle or housing unit of the embodiment similar to FIGS. 1-15.

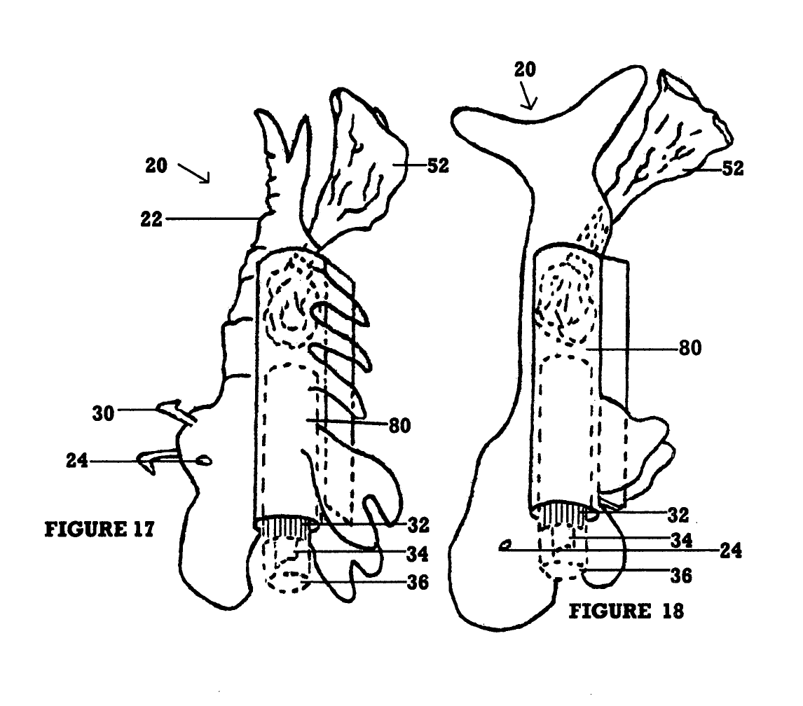

FIGS. 17-18 illustrates perspective views of the embodiments in different shaped receptacles or housing units 22 and displays the interior vehicle windshield/window cleaning kit with the modified one piece cleaning unit 80 shown in FIG. 16. FIG. 17-18 show the one piece cleaning unit 80 inserted in the receptacle or housing unit 22 of the embodiment. FIGS. 17-18 displays the placement of the eyes 24, nose 24, mouth 28, ears 30, ring assembly 52, towel 50, and synthetic filler 54 within the head portion 60 and the receptacle or housing unit 22 of the embodiment.

FIGS. 1-18 illustrate perspective view of certain shapes of the receptacle or housing unit 22 of the embodiment. These receptacles or housing units 22 will be manufactured in all animal shapes known to human civilization. Examples of such animals are but not limited to: a dog, cat, whale, crab, shark, etc. This embodiment's receptacle or housing unit 22 and head portion 60 of the receptacle or housing unit will be in various fabrics, sizes, shapes and colors.

FIGS. 1-18 will show embodiments of the receptacle or the housing unit of the present invention in various animals, shapes, sizes, fabrics or colors. With respect for the FIGS. 1-18 descriptions, it is to be obvious that the dimensional relationships for the parts of the embodiment will include variations in size, materials, shape, forms, function and manner of operational assembly used, and are deemed readily apparent and obvious to one skilled in the art, and all equivalent relationships to these illustration in the drawing and descriptions. FIGS. 1-18 illustrations perspective views of these embodiments are considered as only one illustration of the principles of the receptacle or housing unit 22 and the tools intentions for this embodiment. Numerous modifications and changes can occur in production of this embodiment.

These FIGS. 1-18 are not desired to limit the embodiment to the exact construction or description, therefore, modifications and equivalents may be resorted to, and fall within the scope of this embodiment.

FIGS. 16-18 is displaying a modification to the embodiment that may occur in the manufacturing of the interior vehicle windshield/window cleaning kit. When this embodiment is presented to a manufacture or one who is skilled manufacturing fabric, plastic or rubber, all construction modifications will be allowed that may combine the spray bottle, towel receptacle, base/squeegee as a whole piece to be inserted into the receptacle or housing unit.

### DRAWING

### Reference Numerals

### Interior Vehicle Windshield/Window Cleaning Kit

20 Inventory
22 Receptacle or housing unit
24 Eyes
26 Nose
28 Mouth
30 Ears
32 Neck of spray bottle
34 Nozzle of spray bottle
36 Cap of spray bottle
38 Tube of spray bottle
40 Base of spray bottle
42 Towel tube receptacle
44 Stitching of towel tube receptacle
46 Base or handgrip for squeegee
48 Squeegee
50 Ring attachment for towel
52 Towel
54 Synthetic filler
56 Cover or flap to hide cap/nozzle
58 Stitching on receptacle/housing
60 Head portion of receptacle/housing unit
62 Top/head opening of receptacle
64 Interior of receptacle or housing unit
66 Bottom/rear opening of receptacle
68 Middle opening of receptacle/housing unit
70 Stitching on base/squeegee
72 Panels of fabric
74 Stitching of cover/flap
80 All in one combination cleaning tool

The embodiments of the invention in which an exclusive privileges or property is claimed are defined as below:

1. A portable lightweight handheld interior vehicle windshield/window cleaning kit comprising: a) a housing unit having a body portion receptacle and a head portion receptacle connected to said housing and said housing containing; b) a integral spray bottle inserted in the front portion of said body portion of said housing; c) a integral handgrip or base connected to a squeegee blade or a base squeegee blade combination inserted in the middle portion of said body portion of said housing; d) a integral towel tube receptacle integral inserted in the bottom portion of said body portion of said housing; or i) if conceivable during manufacturing of said housing, a one piece integral cleaning tool for insertion into said body portion of said housing; e) synthetic filler to shape said housing to ensure the recognition of a animal know to human civilization; f) a towel secured to a ring assembly thereof for inserting within the receptacle of said housing; g) said housing made of lightweight fabric or plastic allowing cooperative means of move ability and portability within the vehicle transporting said housing; h) of a size and shape that sits on a dashboard or car console conveniently within reach for ready access by the operator of a vehicle.

2. A portable lightweight hand held interior vehicle windshield/window cleaning kit as recited in claim 1 wherein: said housing contains a head portion receptacle and a body portion receptacle; said head and body portion receptacle are made of panels of fabric or plastic and are patterned after the shapes of animals know to human civilization; said head and body portion receptacles are sealed at the perimeters to form one receptacle or housing unit; three openings will be constructed during this sealing of said head and body portion receptacle for the insertion of the spray bottle, base of squeegee, squeegee and the towel tube receptacle of the animal represented in said head and body portion receptacle.

3. A portable lightweight hand held interior vehicle windshield/window cleaning kit as recited in claim 2 wherein: said housing will be in many shapes, colors and sizes; said head portion receptacle is to contain eyes, ears, nose and mouth on the exterior; said body portion receptacle will contain a spray bottle, handgrip, squeegee and towel tube receptacle within the interior; said housing will contain synthetic filler within the interior of said head and body portion receptacle to ensure the recognition of the animal representing the shape of said housing.

4. A portable lightweight hand held interior vehicle windshield/window cleaning kit as recited in claim 3 wherein: said housing can range in various sizes; said housing should not be of a size that would block the view of a driver while sitting on the dash board of the vehicle; said housing will be in animal shapes known to human civilization; such as, but not limited to dogs, cats, whales, crabs, etc., in various colors, but not limited to black, white, gray, etc, and in various fabrics, but not limited to wool, cotton, plastic, etc.

5. A portable lightweight hand held interior vehicle windshield/window cleaning kit as recited in claim 1 wherein: said housing unit made up of said receptacle with three constructed openings; a front/top opening for the insertion of the spray bottle; the spray bottles will range from 1 to 8 ounce bottles, made of plastic or a light weight metal; said spray bottle will then be inserted and secured into said front/top opening of said receptacle; said spray bottle will have a cap, pump nozzle and tube, neck with threads and a spray bottle base.

6. A portable lightweight hand held interior vehicle windshield/window cleaning kit as recited in claim 5 wherein: said spray bottle cap can be opened to expose said pump nozzle which will apply the liquid inside the spray bottle to the windshield or window; said spray cap will then be closed in some fashion that will cover the actual said cap and pump nozzle of said spray bottle; said closure will be either an extra piece of material attached with a snap, hook or string on said housing; said head portion of some receptacles will cover said cap and nozzle of said housing.

7. A portable lightweight hand held interior vehicle windshield/window cleaning kit as recited in claim 1 wherein: said housing made with three constructed openings; a middle opening for the insertion of a base and squeegee; said base can range is various widths, thickness and lengths; said base can be manufactured of plastic, rubber, styrofoam, metal or anything suitable for this design; said squeegee having an elongated dimension and a relatively narrow transverse dimension cleaning blade which attaches to said base.

8. A portable lightweight hand held interior vehicle windshield/window cleaning kit as recited in claim 7 wherein: said base and squeegee can range in length and depth; said base and squeegee should be no longer than said middle opening; said squeegee can be made of any material know to one skilled in the art of manufacturing squeegees; said base and squeegee when combined in said receptacle will be used as the handgrip and run down said middle opening of said receptacle; said base and squeegee are then secured into said receptacle by bringing the two sides of receptacle together at said middle opening; said two sides are attached with glue or stitching to form the underside or base or handgrip of said housing; said base and squeegee are attached in a manner that the operator will be able to drag said squeegee across the windshield/window of the vehicle to remove dirt and debris off the glass.

9. A portable lightweight hand held interior vehicle windshield/window cleaning kit as recited in claim 1 wherein: said housing made up of three constructed openings; a bottom or rear opening for the insertion of the towel tube receptacle into the said housing; said towel tube receptacle will be made of plastic, PVC, metal or paper; said towel tube receptacle will be used for easy insertion or connection of the towel to the said housing.

10. A portable lightweight hand held interior vehicle windshield/window cleaning kit as recited in claim 1 wherein: said housing is filled with synthetic filler allowing receptacle to take on the size and shape of a animal know to human civilization.

11. A portable lightweight hand held interior vehicle windshield/window cleaning kit as recited in claim 1 wherein: said housing unit is equipped with a detachable absorbing towel to wipe off excess fluid from the windshield/windows; said towel will come with a plastic or metal ring assembly or tube smaller in diameter than that of the said towel tube receptacle for easy insertion and/or connecting to the said towel tube receptacle; said absorbing towel made of any fabric will come in many shapes, colors and sizes; said towel can carry words, signs, logos or pictures.

12. A portable lightweight easy accessible handheld interior vehicle windshield/window cleaning kit comprising: a) a housing unit having a body portion receptacle and a head portion receptacle connected to said housing containing i) if conceivable during manufacturing of this said housing, a one piece integral cleaning tool for insertion into body portion receptacle within said housing; e) synthetic filler to shape said housing receptacles to take on the reorganization of animals know to human civilization; f) a towel secured to a ring assembly thereof for inserting there within the receptacle of said housing; g) said housing made of lightweight fabric or plastic allowing cooperative means of move ability and portability within the vehicle transporting said housing; h) of a size and shape that sits on a dashboard or car console conveniently within reach for ready access by the operator of a vehicle.

13. A portable lightweight hand held interior vehicle windshield/window cleaning kit as recited in claim 12 wherein: said head and body receptacles are sealed at the perimeters to form one receptacle or housing unit; one opening will be constructed during this sealing in the said receptacle for the insertion a one piece integral cleaning tool; said cleaning tool will be designed and manufacture as a one piece tool consisting of a cap, nozzle pump, cylinder for cleaning solution, a cylinder to hold the towel, a squeegee and a base for a hand grip as one unit; said unit could be made out of plastic or rubber or anything else known to one in the art of manufacturing this combined tool; said cleaning tool will then be inserted into the said one opening in the said receptacle and sealed to form the said housing.

14. A portable lightweight hand held interior vehicle windshield/window cleaning kit as recited in claim 12 wherein: said housing will be made of any lightweight fabric or plastic allowing the driver to grasp and handle the said housing; said housing allows for easy move ability of said housing without leaving the operation station of the vehicle; said housing will be a easy operational cleaning unit with everything needed to clean the windshield or window.

15. A portable lightweight hand held interior vehicle windshield/window cleaning kit as recited in claim 12 wherein: said housing is of a size and shape that it conveniently sits on the dashboard or car console of the vehicle; said receptacle is within reach for ready access in the event of sudden extreme weather conditions that require emergency measures without the operator leaving the operation station of the vehicle.

16. Other objects and advantages of the present invention will become apparent form a careful reading of the detailed description provided herein, with appropriate reference to the accompanying drawings.
